(19) United States
(12) Patent Application Publication
(10) Pub. No.: US 2017/0018168 A1
(43) Pub. Date: Jan. 19, 2017

(54) AUXILIARY ALARM NOTIFICATION

(71) Applicant: Microsoft Technology Licensing, LLC, Redmond, WA (US)

(72) Inventors: Joseph Anthony Beernink, Issaquah, WA (US); Fernando Godinez, Sammamish, WA (US); Eric Joseph Barry, Carnation, WA (US)

(21) Appl. No.: 14/800,433

(22) Filed: Jul. 15, 2015

(51) Int. Cl. G08B 25/01; G08B 21/14; G08B 7/06; G08B 17/10

(52) U.S. Cl. CPC G08B 25/016; G08B 17/10; G08B 21/14; G08B 7/06

(57) ABSTRACT

A notification device for providing an auxiliary alarm. The notification device includes an auxiliary alarm device configured to provide sensory feedback. A registration module is included that is configured to listen for an available auxiliary alarm system. The registration module is also configured to register the notification device with the auxiliary alarm system without providing personally identifying information to the auxiliary alarm system. An auxiliary alarm receiving module is included that is configured to receive an auxiliary alarm code from the auxiliary alarm system. An auxiliary alarm activation module is coupled to the auxiliary alarm device and is configured to activate the auxiliary alarm device to provide an auxiliary alarm.

### BACKGROUND

### Background and Relevant Art

Alarm systems provide alerts to users. In some cases, these alerts have been used to prevent injury and/or death. Typical alarm systems provide an audible alarm to warn the users of danger. For example, a typical smoke alarm system provides an audible alarm to warn the users of potential fire danger. A typical carbon monoxide alarm system similarly provides an audible alarm when levels of carbon monoxide approach or exceed safe levels.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a notification device for providing an auxiliary alarm. The notification device includes an auxiliary alarm device configured to provide sensory feedback. A registration module is included that is configured to listen for an available auxiliary alarm system. The registration module is also configured to register the notification device with the auxiliary alarm system without providing personally identifying information to the auxiliary alarm system. An auxiliary alarm receiving module is included that is configured to receive an auxiliary alarm code from the auxiliary alarm system. An auxiliary alarm activation module is coupled to the auxiliary alarm device and is configured to activate the auxiliary alarm device to provide an auxiliary alarm.

Another embodiment illustrated herein includes an auxiliary alarm communication device for communicating an auxiliary alarm. The auxiliary alarm communication device includes a registration module configured to receive registration information from a notification device. An alert receiving module is included that is configured to receive an alarm code from a primary alarm system. An auxiliary alarm communication module is included that is configured to send an auxiliary alarm code to the notification device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 is a conceptual drawing of an embodiment of an auxiliary alarm system.

FIG. 2 is a conceptual drawing of a building in which an embodiment of an auxiliary alarm system may be used.

FIG. 3 is an embodiment of a method for providing an auxiliary alarm.

FIG. 4 is another embodiment of a method for providing an auxiliary alarm.

FIG. 5 is a further embodiment of a method for providing an auxiliary alarm.

FIG. 6 is a still further embodiment of a method for providing an auxiliary alarm.

FIG. 7 is a block diagram of an embodiment of a notification device.

FIG. 8 is an embodiment of a method for communicating an auxiliary alarm.

FIG. 9 is an embodiment of an auxiliary alarm communication device.

### DETAILED DESCRIPTION

At least one embodiment disclosed herein implements an alarm system that communicates an auxiliary alarm to a user. In one embodiment, the alarm system communicates an auxiliary alarm to a user using a different sensory pathway than a primary alarm. For example, the primary alarm may use a sensory pathway with diminished sensory acuity. Diminished sensory acuity may mean that a user is unable to appreciate and/or recognize a first alarm provided by an alarm system.

An auxiliary alarm delivered through a sensory pathway capable of detecting the auxiliary alarm may be used to alert a user with diminished sensory acuity in addition to a first alarm delivered through the sensory pathway with diminished acuity. In one example, for a user with diminished hearing acuity, an auxiliary alarm may be delivered haptically, visually, through another non-auditory pathway, or combinations thereof in addition to a first audible alarm. In another example, a haptic, audible, or other non-visual auxiliary alarm, or combinations thereof may be used to alert a user with diminished visual acuity which may be in addition to a visual first alarm.

In some embodiments, an auxiliary alarm may function as the primary alarm. For example, in the unlikely event that a first, primary alarm were to fail (e.g., a speaker of a smoke detector were broken), the auxiliary alarm would then function as the primary alarm. Otherwise, an auxiliary alarm is in addition to a first, primary alarm.

An auxiliary alarm may be provided, in some embodiments, using the same sensory pathway as a user's diminished sensory pathway, but the auxiliary alarm may be provided in a different manner than a primary alarm. For example, a user with diminished hearing acuity may be capable of hearing sounds of a lower frequency than the frequency generated by the audible primary alarm. Thus, an audible auxiliary alarm of a lower frequency than the primary alarm may be sufficient to warn the user of a situation.

In some embodiments, an auxiliary alarm may be provided in addition to a plurality of primary alarms. However, the user may be unable to appreciate the plurality of primary alarms and an auxiliary alarm may be provided using a different sensory pathway than the sensory pathways used by the primary alarms. For instance, a fire alarm may provide both an audible and a visual alarm. The auxiliary alarm may be provided in a haptic manner. The auxiliary alarm may be provided using the same sensory pathway as one or more of the primary alarms, but in a manner that is capable of being appreciated by the user. For example, the auxiliary alarm may be provided in an audible and/or visual manner that is capable of being appreciated by the user (e.g., at a lower frequency and/or a higher brightness).

At least one embodiment disclosed herein registers a notification device with an auxiliary alarm communication device without providing personally identifying information from a user to the auxiliary alarm communication device. Personally identifying information may include information that identifies a user, such as a user name, password, name, telephone number, email address, physical address, or the like. At least one embodiment disclosed herein registers a notification device with an auxiliary alarm communication device without providing any personally identifying information while limiting alarms not sent by the auxiliary alarm communication device. Alarms not sent by the auxiliary alarm communication device may include false alarms provided, for example, as a prank.

One way that a notification device may be registered with an auxiliary alarm communication device without providing personally identifying information to the auxiliary alarm system includes generating registration information that does not include the personally identifying information. For example, the notification device may register with the auxiliary alarm communication device using a generated token that does not include personally identifying information. This registration information, such as the generated token, may be used to determine whether an alert code from the auxiliary alarm communication device is a valid alert code.

Another way that a notification device may be registered with an auxiliary alarm communication device without providing personally identifying information to the auxiliary alarm system includes simply listening for an auxiliary alarm code to be sent to the notification device. In this way, the notification device is “pre-registered” with any available auxiliary alarm system, because the auxiliary alarm system simply sends the auxiliary alarm code.

At least one embodiment disclosed herein provides an auxiliary alarm specific to a location of a user. For example, the location of a user may include a last known location of a user. In another example, the location of a user may include in which building a user is, in which area of the building a user is, in which room in the building a user is currently (was previously, may be predicted to be, or the like), other location information, or combinations thereof.

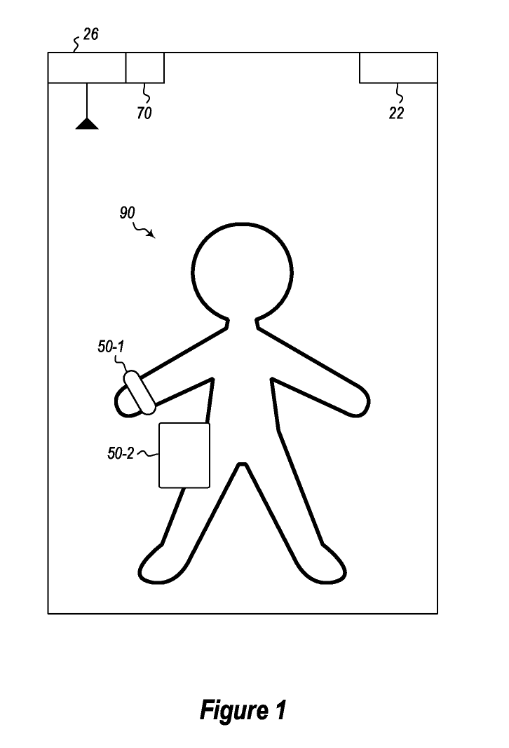

Referring now to FIG. 1, a conceptual drawing of a structure 1 in which an embodiment of an auxiliary alarm system may be used is shown. The structure 1 includes a primary alarm system and an auxiliary alarm system. The primary alarm system may include at least one alert detector 22 (e.g., a fire alarm). The alert detector 22 may be configured to raise a primary alarm if an alert (e.g. a fire) is detected. An alert detector 22 may include an alert generator, such as an audible alert generator (e.g., a speaker) and/or a visual alert generator (e.g., a light). Additionally or alternatively, other alert generators may be used with the primary alarm system.

The primary alarm system may include a communication device 26. The communication device 26 may be a wireless router (such as a Wi-Fi router), a cell access point, a repeater, an extender, other communication devices, or combinations thereof.

The auxiliary alarm system may utilize and/or may replace components of the primary alarm system. The auxiliary alarm system includes at least one notification device 50 and at least one auxiliary alarm communication device 70. A notification device 50 may be a wearable device, such as notification device 50-1. In addition or alternatively, a notification device 50 may be a mobile device (a smart phone, tablet, etc.), such as notification device 50-2, that may be worn and/or carried by a user.

The auxiliary alarm communication device 70 may be in electronic communication with the communication device 26 and/or the alert sensor 22. An auxiliary alarm communication device 70 may be in electronic communication with the notification device 50.

The following is an example scenario of the usage of an auxiliary alarm system. In this example, the alert detector 22 is a fire alarm. Upon detecting a fire, the alert detector 22 generates a primary alarm (e.g., an audible alarm). The auxiliary alarm communication device 70 may detect the primary alarm (by an audible alarm detector, by receiving an alert code from the alert detector 22, etc.). The auxiliary alarm communication device 70 may provide an auxiliary alarm code to at least one of the notification devices 50-1, 50-2. Upon receiving the auxiliary alarm code, the notification device 50 may generate an auxiliary alarm.

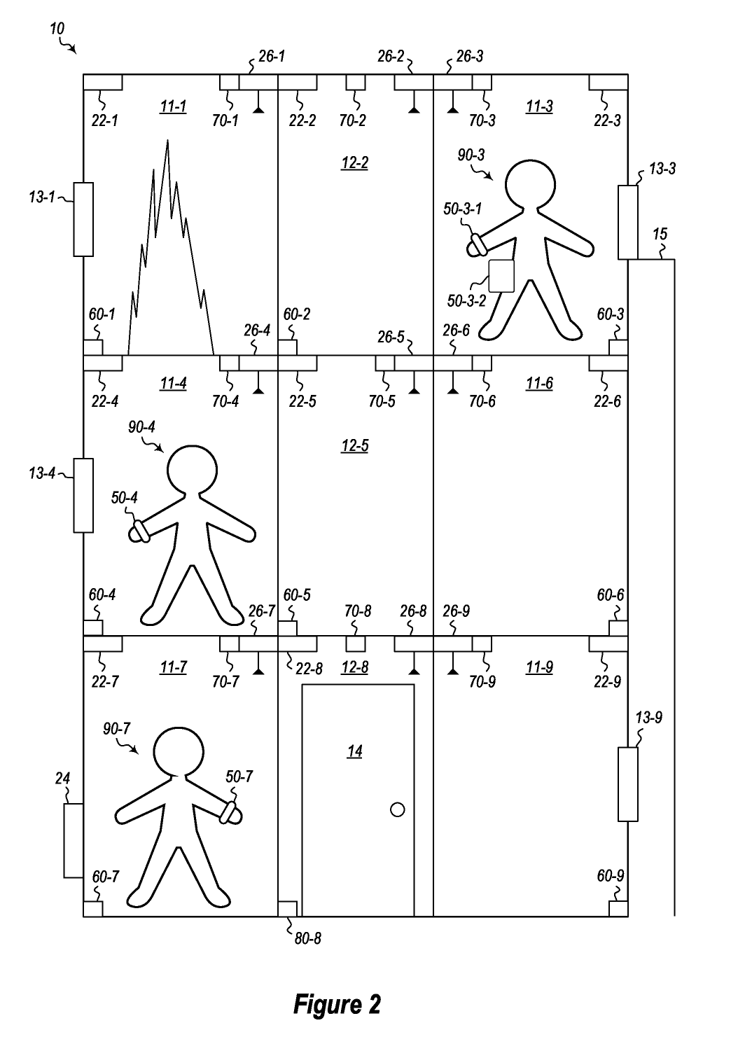

Referring now to FIG. 2, a conceptual drawing of a building 10 in which an embodiment of an auxiliary alarm system may be used is shown. The embodiment of an auxiliary alarm system illustrated in FIGS. 1 and 2 are merely example environments (e.g., structure 1 and building 10) that are not intended to limit the environments in which an auxiliary alarm system, such as the auxiliary alarm systems of FIGS. 1 and 2, can be used. Other example environments may include indoor and/or outdoor environments, larger and/or smaller buildings, a user's primary dwelling place, other environments, or combinations thereof.

The auxiliary alarm system, in the illustrated embodiment, is installed in a building 10. The building 10 may include at least one room 11, hallway 12, window 13, entrance/exit 14, fire escape 15, stairs (not shown), elevators (not shown), other building features, or combinations thereof.

The building 10 includes a primary alarm system that is used to generate a primary alarm. The auxiliary alarm system is in electronic communication with the primary alarm system. The primary alarm system may include at least one alert detector 22. As shown in FIG. 1, each room 11 (including rooms 11-1, 11-3, 11-4, 11-6, 11-7, 11-9) and each hallway 12 (including the hallways 12-2, 12-5, 12-8) may include at least one alert detector 22 (including detectors 22-1, 22-3, 22-4, 22-6, 22-7, 22-9 and 22-2, 22-5, 22-8, respectively). In other embodiments more or fewer alert detectors 22 may be used. Although a single alert detector 22 is shown in each room 11 or hallway 12, multiple alert detectors 22 including alert detectors of different types or the same type may be used. For example, room 11-1 may include multiple alert detectors 22-1, such as a smoke detector, a fire detector, and a carbon monoxide detector. In another example, room 11-1 may not have any alert detectors 22.

The alert detectors 22 may be similar to the alert detectors 22 described in FIG. 1. For example, each alert detector 22 may be configured to raise a primary alarm if an alert is detected.

Each alert detector 22 may be in electronic communication with an alarm panel 24. The alarm panel 24 may be configured to raise a primary alarm in an alert detector 22 that has detected an alert and/or in other alert detectors 22 that may or may not have detected the alert.

The building 10 may include one or more communication devices 26. For example, as shown in FIG. 1, each room 11 may include a wireless router (such as a Wi-Fi router), a cell access point, a repeater, an extender, other communication devices, or combinations thereof.

The auxiliary alarm system may utilize and/or may replace components of the primary alarm system. As illustrated in FIG. 2, the auxiliary alarm system includes at least one notification device 50 and at least one auxiliary alarm communication device 70.

One or more communication devices 26 may be in electronic communication with an auxiliary alarm communication device 70. As shown in FIG. 2, at least one auxiliary alarm communication device 70 (e.g., auxiliary alarm communication device 70-1) may be directly incorporated into a communication device 26 (e.g., communication device 26-1) and/or at least one auxiliary alarm communication device 70 (e.g., auxiliary alarm communication device 70-2) may be physically separate from (but in electrical communication with) a communication device 26 (e.g., communication device 26-2). Furthermore, components of the primary alarm system may be hardwired and/or wirelessly in communication with the auxiliary alarm system. For example, at least one auxiliary alarm communication device 70 may be in electronic communication with the alarm panel 24, at least one communication device 26, the alert sensor 22, or combinations thereof.

A notification device 50 may notify the user of an alert. Examples of notifications will be discussed below. As shown in FIG. 1, a notification device 50 may be a wearable device, such as notification device 50-3-1. A notification device 50 may be a mobile device (a smart phone, tablet, etc.), such as notification device 50-3-2, that may be worn and/or carried by a user. A notification device 50 may be in electronic communication with at least one auxiliary alarm communication device 70, as will be further described below.

In one example of a scenario where an embodiment of an auxiliary alarm system may be used, a user 90-4 is located in a room 11-4. A fire has been detected by the alert detector 22-1, which in this example is a smoke detector, and a first audible alarm is raised. However, the user 90-4 has diminished auditory acuity and is unable to appreciate the first alarm. Were the user 90-4 to be alone in the building, the user 90-4 likely would not become aware of the fire until it is too late. Fortunately, the user 90-4 has a notification device 50-4 and the building 10 includes an auxiliary alarm communication device 70 to which the notification device 50-4 is connected. In this example, the notification device 50-4 is connected to the auxiliary alarm communication device 70-4 in the room 11-4. The notification device 50-4 provides an auxiliary alarm to the user 90-4 that may notify the user 90-4 that a fire is in the building 10.

For ease of understanding, the disclosure will now turn toward embodiments of components of an auxiliary alarm system and methods of providing auxiliary alarms. Further examples of scenarios in which various embodiments of an auxiliary alarm system may be described throughout.

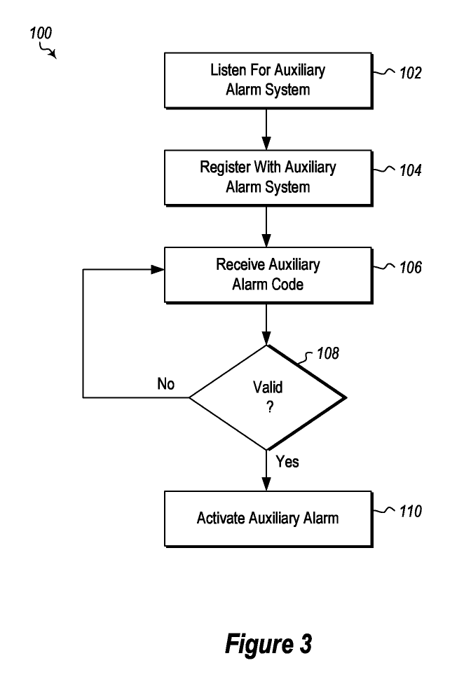

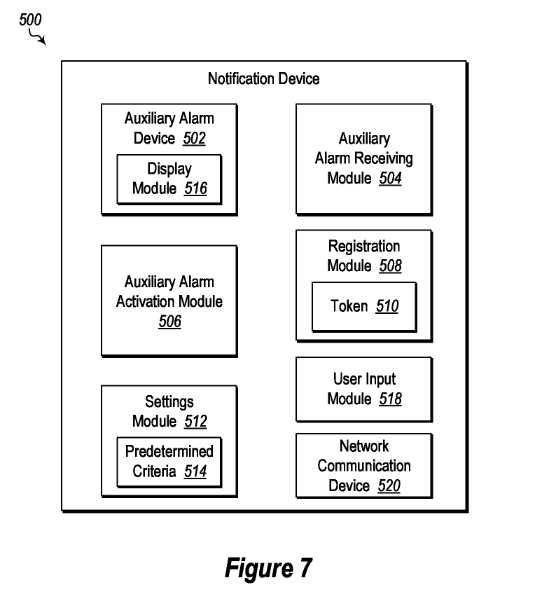

Referring now to FIG. 3, a method 100 for providing an auxiliary alarm is illustrated. The method 100, and any other methods disclosed herein using a notification device, may be implemented in a notification device such as the notification devices 50 described in connection with FIG. 1 and/or notification device 500 described in connection with FIG. 7. For example, the notification device may be the notification device 50-3-1 (e.g., a Microsoft Band available from Microsoft Corporation of Redmond, Wash.) or the notification device 50-3-2 (e.g., a smart phone and/or tablet running Windows 10 Mobile available from Microsoft Corporation of Redmond, Wash.).

The method 100 includes acts for providing an auxiliary alarm. The present embodiment of a method 100 may include more or fewer acts, as shown, for example, in other embodiments described herein. The method 100 may include listening for an auxiliary alarm system (act 102). Listening for an auxiliary alarm system may include searching for a network being broadcast by an auxiliary alarm communication device. In another example, listening for an auxiliary alarm system may include listening for an availability announcement from an auxiliary alarm communication device. Other examples are provided below.

The method 100 may include registering with an auxiliary alarm system (act 104). Registering with an auxiliary alarm system may include providing registration information to an auxiliary alarm communication device. Registering the notification device may include sending the registration information over a network. In some embodiments, the registration information includes information relating to the device, but does not include personally identifying information relating to the user (other than the device related information). Further examples of registering are provided below (e.g., act 302 in method 300).

The method 100 may include receiving an auxiliary alarm code (act 106). The notification device may listen for an auxiliary alarm code from an auxiliary alarm communication device. Examples of auxiliary alarm codes and of receiving auxiliary alarm codes (e.g., act 202 in method 200, act 412 in method 400) are provided below.

The method 100 may include determining whether an auxiliary alarm code is valid (act 108). An auxiliary alarm code may be determined to be valid if the auxiliary alarm uses at least a portion of the registration information sent to the auxiliary alarm communication device. Further examples of determining the validity of an auxiliary alarm code are provided below (e.g., act 304 of method 300).

If it is determined that the auxiliary alarm code is valid, an auxiliary alarm may be activated (act 110). The auxiliary alarm may be a haptic, visual, audible, or other sensory alarm, or combinations thereof. Further examples of auxiliary alarms are provided below (e.g., various alarm styles described in connection with method 400).

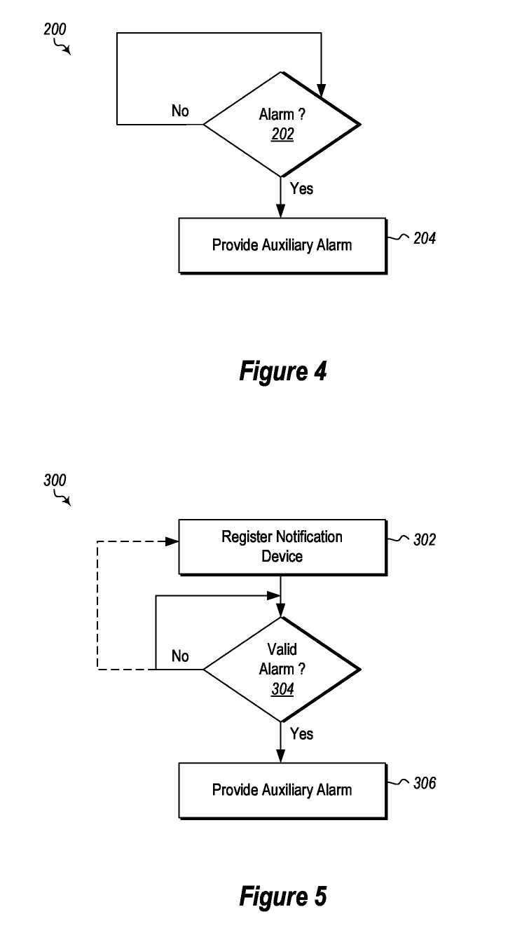

Referring now to FIG. 4, a method 200 for providing an auxiliary alarm is illustrated. The method 200 includes acts for providing an auxiliary alarm. The method 200 includes determining if an auxiliary alarm code has been received (act 202). In this embodiment, a notification device listens for an auxiliary alarm code to be sent to the notification device. The auxiliary alarm communication device may broadcast an auxiliary alarm code. One way that this may be accomplished is by sending the auxiliary alarm code over the Radio Data System (RDS). For example, the auxiliary alarm communication device may send the auxiliary alarm code using a radio frequency modulator with RDS capability.

The notification device would then receive the auxiliary alarm code from the radio frequency modulator of the auxiliary alarm communication device. In another example, the auxiliary alarm communication device may continually broadcast the availability of the auxiliary alarm system (e.g., using Multicast or Broadcast over User Datagram Protocol (UDP)). In this example, the notification device may search for the auxiliary alarm system based on the broadcast availability. In some embodiments, the use of a broadcast network may limit the connection of the notification device to the current (i.e., closest) switch available to the notification device.

If an auxiliary alarm code is received, the notification device provides an auxiliary alarm (act 204). The auxiliary alarm may be a haptic, visual, audible, or other sensory alarm, or combinations thereof. If an auxiliary alarm code is not received, the notification device again determines if an auxiliary alarm code has been received (act 202). A time period or other power saving option between determinations (act 202) may be included.

In some embodiments, no registration information is provided by the notification device to the auxiliary alarm system. This may prevent the sharing of personal information with the auxiliary alarm system. By not providing any personal information, a user's privacy may be more protected. In at least one embodiment where no registration information is provided, false alarms may be more likely. For example, if another user knew the necessary RDS information to provide an auxiliary alarm, the other user could potentially send a false alarm signal via a radio frequency modulator with RDS capability. However, many users may prefer to risk receiving false alarms rather than providing personal information to an alarm system.

FIG. 5 illustrates a method 300 for providing an auxiliary alarm. The method 300 includes registering a notification device (act 302). Registering the notification device may include providing registration information to an auxiliary alarm communication device, which may reduce the likelihood of a prank or other false alarm from being received. Registering the notification device may include sending the registration information over a network.

In some embodiments, the registration information includes information relating to the device, but does not include personally identifying information relating to the user (other than the device related information). In other words, the registration information is anonymous relative to the user. For example, the registration information may include a device identifier (e.g., a MAC address, serial number, a Wi-Fi address, a Bluetooth address, a version number, other device identifying information, or combinations thereof), an RFID tag (e.g., for use with an RFID door scanner), a token generated using a certificate or other information associated with the notification device, a random number string, a timestamp, other registration information, or combinations thereof.

The method 300 includes determining if an auxiliary alarm code is valid (act 304). In this embodiment, a notification device listens for an auxiliary alarm code to be sent to the notification device. An auxiliary alarm code may be determined to be valid if the auxiliary alarm uses at least a portion of the registration information sent to the auxiliary alarm communication device. For example, if the registration information included a device identifier, then if the auxiliary alarm code includes at least a portion of the device identifier, the auxiliary alarm code would be determined to be valid. In another example, if the auxiliary alarm code includes at least a portion of a sent random number string, the auxiliary alarm code would be determined to be valid.

Other more complex registration information may be used. For example, security algorithms could be used to encode and/or encrypt the registration information sent to the auxiliary alarm communication device. However, more complex solutions may reduce the speed at which this new technology may be adopted. Thus, it may be desirable, in some embodiments, to reduce the amount of complexity in the system in favor of more rapid adoption.

If an auxiliary alarm code is received (and determined to be valid), the notification device provides an auxiliary alarm (act 306). If an auxiliary alarm code is not received (or is received but determined not to be valid), the notification device again determines if an auxiliary alarm code has been received (act 304). This may be done without reregistering the notification device.

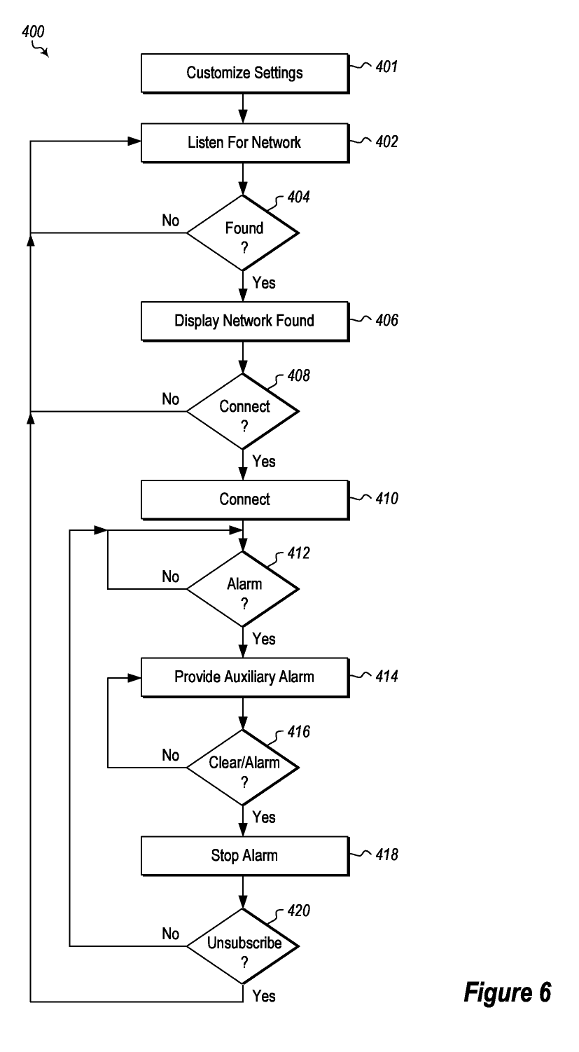

FIG. 6 illustrates a method 400 for providing an auxiliary alarm. The method 400 includes customizing settings for a notification device (act 401). Settings for the notification device may include predetermined criteria, such as alert types, alarm styles, registration modes, other settings, or combinations thereof.

Alert types may include the type of alerts that will be considered valid before providing an auxiliary alarm. Alert types may include an announcement, such as a doorbell, telephone, other announcements, or combinations thereof. Alert types may include threat types such as fire, smoke, tsunami, biological, chemical, flood, human, hurricane, tornado, radiation, nuclear, volcano, wildfire, thunderstorm, other threats, a threat drill, or combinations thereof. Customizing a setting based on a threat type may include selecting for which threat types to provide an auxiliary alarm. For example, a user may select only to provide an auxiliary alarm for fire, smoke, or biological threats.

Alarm styles may include the alarm pathway, the alarm manner, other alarm styles, or combinations thereof. The alarm pathway may include the pathway through which the alarm is communicated to a user. For example, a user may select that all auxiliary alarms are provided through a haptic pathway, a visual pathway, an audible pathway, or combinations thereof. The alarm manner may include the frequency of the alarm, duration of the alarm, intensity of the alarm, other aspects of the auxiliary alarm, or combinations thereof. For example, a user may select that all auxiliary alarms are provided with a desired frequency, duration, and/or intensity.

Various combinations of alarm styles may be selected. A user may customize various alarm styles based on an alert type. For instance, a user may select a haptic alarm, with a low frequency (e.g., ten vibrations per second), having a longer duration (e.g., vibrating for one second), and a high intensity for a fire alarm while selecting a visual alarm with a high frequency (e.g., one-hundred flashes per second), having a shorter duration (e.g., flashing for half of a second), with a low intensity (e.g., 800 lux) for a tornado alarm. In another example, a user may select both a haptic and a visual alarm with varying alarm styles for each type of alert type, the same alarm styles for each alert type, a portion of the alarm styles being the same and a portion of the alarm styles being different for each alert type. In another example, for a haptic auxiliary alarm for a fire, the notification device may spell out the word fire using, for example, Morse code (short short long short, short short, short long short, short). Other combinations are also contemplated. In some embodiments, additional information may be provided with an auxiliary alarm. Examples of such additional information are described below.

A registration mode may include an automatic registration mode, a periodic registration mode, a user-approval registration mode, or other registration modes. An example of an automatic registration mode includes the method 200 for providing an auxiliary alarm described in connection with FIG. 4. In this example, the notification device automatically receives any auxiliary alarm codes sent by an auxiliary alarm communication device without user interaction. Another example of an automatic registration mode includes the method 300 for providing an auxiliary alarm described in connection with FIG. 5. In this example, the notification device may register the notification device (act 302) without user interaction.

A periodic registration mode may include an amount of time for which a notification device may remain registered with an auxiliary alarm communication device. In some embodiments, it may be desirable for a notification device to be connected to the nearest auxiliary alarm communication device. For example, in a large building (e.g., building 10 in FIG. 1), multiple auxiliary alarm communication devices (e.g., auxiliary alarm communication devices 70) may overlap in coverage. Thus, once a user has registered with one auxiliary alarm communication device (e.g., auxiliary alarm communication device 70-1) the user may remain connected to that auxiliary alarm communication device when another auxiliary alarm communication device (e.g., auxiliary alarm communication device 70-7) is closer to the user. Thus, an alarm sent to the other auxiliary alarm communication device (e.g., auxiliary alarm communication device 70-7) may end up being mistakenly sent to a user (e.g., from auxiliary alarm communication device 70-1).

In another embodiment, the notification device may stay permanently registered to an auxiliary alarm communication device. For example, when a user is at home, the user may desire to only register once with a home auxiliary alarm communication device.

One way to improve the accuracy of the auxiliary alarm system may include limiting the amount of time that a notification device is registered with an auxiliary alarm communication device. Thus, by forcing a notification device to periodically reregister, the notification device may select a closer auxiliary alarm communication device.

Another way to improve accuracy is to use the location of the notification device and/or the auxiliary alarm communication device. Various methods and systems may be used to determine the location of the notification device.

For example, a location beacon may be used in at least one room of a building. The location beacon may have a more limited range than an auxiliary alarm communication device such that the location of the notification device may be more easily determined. For instance, referring back to FIG. 1, the range of the auxiliary alarm communication device may include rooms 11-1, 11-2, and 11-4, while the range of a location beacon 60-1 in room 11-1 may include only room 11-1. In another example, the location beacon 60-1 in room 11-1 may include only rooms 11-1 and 11-4 while a location beacon 60-7 in room 11-7 may include rooms 11-7 and 11-4. In this example, the notification device and/or the auxiliary alarm communication device may use the location information from both location beacon 60-1 and 60-7 to determine whether an alert should be provided to a user in room 11-4.

In another example, an entrance/exit beacon (shown as 80-8 in FIG. 1) may be used to determine when a user has entered a building and when the user has left the building (e.g., a user's building status). In this example, an auxiliary alarm communication device and/or a notification device may use a status of the entrance/exit beacon to determine whether to produce an auxiliary alarm. For instance, if a user's building status indicates that the user is in the building during an alert, the user may be notified and/or when the user's building status is out of the building during an alert, the user may not be notified.

In a further example, a notification device may include location tracking modules, such as a global positioning system (GPS) receiver, an accelerometer, a gyroscope, a pedometer, a Wi-Fi triangulation module, other location tracking modules, or combinations thereof. For embodiments with a GPS receiver, when within sufficient line of sight to one or more satellites, a user's position may be tracked. For embodiments with a pedometer, an accelerometer, and a gyroscope, a user's position within a building may be tracked and/or estimated.

The method 400 may include listening for an available network (act 402). Listening for an available network may include searching for a network with an identifier (e.g., an SSID, broadcast header information, other identifiers, or combinations thereof) that signifies the use of an auxiliary alarm system (e.g., Network_Name-AA, where AA signifies an auxiliary alarm enabled communication device). In another example, listening for an available network may include listening for an availability announcement from an auxiliary alarm communication device.

It may be determined (act 404) whether an available network has been found. For example it may be determined whether a network with an acceptable identifier and/or a network broadcasting an availability announcement is available.

If an available network is found, the method 400 may display that a network has been found (act 406). If not, the method 400 may continue to listen for an available network (act 402).

Displaying that a network has been found (act 406) may include displaying through a sensory pathway, such as a visual pathway, audible pathway, haptic pathway, other sensory pathway, or combinations thereof using a display device. For example, for a visual pathway, the notification device may include a visual display such as a display screen (e.g., an LCD, LED, or other display screen). In another example, for a haptic pathway, the notification device may provide a haptic alarm to notify the user that an auxiliary alarm system is available. In a further example, for an audible pathway, the notification device may provide an audible alarm or a verbal alarm indicating that an auxiliary alarm system is available.

The method 400 may then determine whether a user wishes to connect to the available network (act 408). A user may indicate that they wish to connect by touching a portion of the notification device, by moving the notification device in a predetermined way (e.g., as detected by one or more accelerometers and/or one or more gyroscopes), by verbalizing a command to the notification device, by an explicit near field communication (NFC) scan, may otherwise indicate the desire to connect, or combinations thereof.

If it is determined that the user wishes to connect, the method 400 may connect with the available network (act 410). If not, the method 400 may continue to listen for an available network (act 402). Connecting with the available network may include registering the notification device. Registering the notification device may be the same as registering a notification device (act 302) in the method 300 described in connection with FIG. 5.

The method 400 may determine if an auxiliary alarm code has been received (act 412). Determining if an auxiliary alarm code has been received may be the same as determining if an auxiliary alarm code has been received (act 202) in the method 200 described in connection with FIG. 4 and/or may be the same as determining if an auxiliary alarm code is valid (act 304) in the method 300 described in connection with FIG. 5.

If the method 400 determines that an auxiliary alarm code has been received (and/or determined to be valid), an auxiliary alarm may be provided (act 414). If the method 400 does not determine that an auxiliary alarm code has been received, the method 400 may continue to listen for an auxiliary alarm code to determine if an auxiliary alarm code has been received (act 412). Providing an auxiliary alarm (act 414) may be the same as providing an auxiliary alarm (act 204, act 306) described in connection with FIGS. 4 and 5.

The method 400 may then determine whether to clear the alarm (act 416). Whether to clear an alarm may be determined by the user (e.g., by providing instructions to the notification device), by predetermined criteria, such as customized settings (e.g., in a periodic registration mode), by other methods, or combinations thereof. Example instructions that may be provided to the notification device may include touching a portion of the notification device, moving the notification device in a predetermined way, verbalizing a command to the notification device, leaving the area of an alarm (e.g., as determined by a NFC scanner), otherwise indicating the desire to clear the alarm, or combinations thereof.

If the method 400 determines that the alarm should be cleared, the notification device may stop providing the auxiliary alarm (act 418). If the method 400 determines that the alarm should persist, the method 400 may continue to provide the auxiliary alarm (act 414).

Alternatively or in addition to using a periodic registration mode to limit the time that a notification device is registered with an auxiliary alarm system, the method 400 may determine whether to unsubscribe from the auxiliary alarm system (act 420). For example, it may be determined to unsubscribe from the auxiliary alarm system if the location of the notification device is outside of a predetermined perimeter, if a predetermined time limit has expired, if a signal quality from the auxiliary alarm communication device drops below a predetermined value, if an NFC enabled notification device checks out, other unsubscribing factors, or combinations thereof. If it is determined that the notification device should be unsubscribed from the auxiliary alarm system, the method 400 may end or may listen for an available auxiliary alarm network (act 402). If it is determined that the notification should not unsubscribe, then the method may determine if an auxiliary alarm code has been received (act 412).

Various acts from other methods (e.g., methods 300, 400) have been described as being incorporable into the method 400 described. In addition or in the alternative, the method 400 describes various acts that may be incorporated into other methods described herein. For example, customizing settings for a notification device (act 401) may be incorporated into the methods 200, 300 in FIGS. 4 and 5 or any other method described herein.

FIG. 7 illustrates a notification device 500 for providing an auxiliary alarm. The notification device 500 includes an auxiliary alarm device 502 configured to provide sensory feedback to a user. The auxiliary alarm device 502 may be used to perform one or more of the method acts described herein. For example, the auxiliary alarm device 502 may provide the auxiliary alarm to the user as described relative to acts 204, 306, 414 described in connection with FIGS. 4-6, respectively.

The notification device 500 includes an auxiliary alarm receiving module 504 configured to receive an auxiliary alarm from an auxiliary alarm system. The auxiliary alarm receiving module 504 may be used to determine whether an auxiliary alarm has been received. For example, the auxiliary alarm receiving module 504 may determine whether an auxiliary alarm has been received as described relative to act 202 and act 412 in FIGS. 4 and 6, respectively and/or whether an auxiliary alarm is valid as described relative to act 304 in FIG. 5.

An auxiliary alarm activation module 506 is included in the notification device 500. The auxiliary alarm activation module 506 may be used to activate the auxiliary alarm device 502 to provide an auxiliary alarm. The auxiliary alarm activation module 506 may be associated with the auxiliary alarm receiving module 504. For example, the auxiliary alarm activation module 506 may receive instructions form the auxiliary alarm receiving module 504.

The notification device 500 may include a registration module 508. The registration module 508 may be used to register the notification device 500 as described in connection with act 302 in FIG. 5. The registration module 508 may be used to connect with an available network as described in connection with act 410 in FIG. 6. The registration module 508 may include registration information. For example, as shown in FIG. 7, the registration module 508 may include a notification device token 510. The registration information may be used to determine whether auxiliary alarm codes are valid, as described, for instance, in connection with act 304 in FIG. 5.

A settings module 512 may be included in the notification device 500. The settings module 512 may include predetermined criteria 514, such as alert types, alarm styles, registration modes, other settings, or combinations thereof. For example, the predetermined criteria 514 may be selected by customizing settings as described in connection with act 401 in FIG. 6.

The auxiliary alarm device 502 may include a display module 516. The auxiliary alarm device 502 and/or display module 516 may include a haptic feedback device, a visual feedback device, an audible feedback device, other sensory feedback devices, or combinations thereof. The display module 516 may display information to a user. For example, the display module 516 may display that an available network has been found as described relative to act 406 in connection with FIG. 6. The display module 516 may display a query to a user. For example, the display module 516 may prompt the user to decide whether to clear an alarm as described in connection with act 416 in FIG. 6. In another example, the display module 516 may display what settings to customize as described in connection with act 401 in FIG. 6.

A user input device 518 may be included in the notification device 500. The user input device 518 may be used to receive inputs from a user. For example, the user input device 518 may be used to receive inputs for customizing settings as described in connection with act 401 in FIG. 6, to receive inputs for connecting to a network from a user as described in connection with act 408 in FIG. 6, to receive inputs for clearing an alarm as described in connection with act 416 in FIG. 6, to receive inputs for unsubscribing from an auxiliary alarm system as described in connection with act 420 in FIG. 6, to receive other inputs from a user, or combinations thereof.

The notification device 500 may include a network communication device 520. The network communication device 520 may include a wireless transceiver capable of communicating wirelessly with an auxiliary alarm communication device. The wireless transceiver may be capable of communicating over at least one of the following protocols including Wi-Fi (e.g., 802.11 standards), Bluetooth, ZigBee (e.g., 802.15.4 standard), Microsoft Media Server (MMS), Global System for Mobile Communications (GSM), Code Division Multiple Access (CDMA), Z-Wave, other wireless protocols, or combinations thereof. The network communication device 520 may receive an auxiliary alert code from an auxiliary alarm communication device.

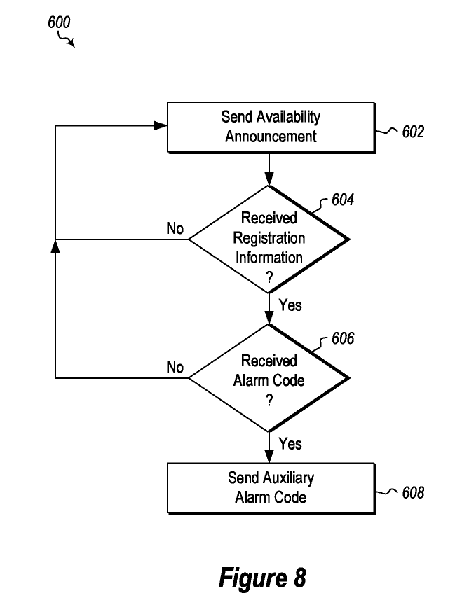

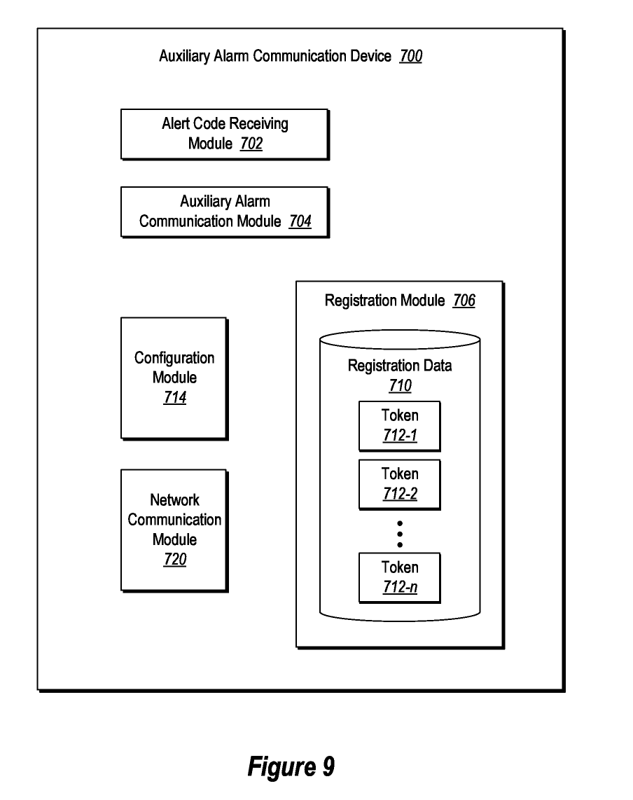

FIG. 8 illustrates a method 600 for communicating an auxiliary alarm. The method 600 may be implemented in an auxiliary alarm communication device such as the auxiliary alarm communication devices 70 described in connection with FIG. 1 and/or auxiliary alarm communication device 700 described below in connection with FIG. 9.

The method 600 may include sending an availability announcement (act 602). Sending an availability announcement may include sending an identifier, such as the identifiers described in connection with FIG. 6, that signifies the use of an auxiliary alarm system.

The method 600 may include determining whether registration information has been received (act 604). For example, registration information may be received from a notification device. Receiving registration information from a notification device may include storing the registration information, for example, in a memory associated with an auxiliary alarm communication device. Registration information may be received over a network. The auxiliary alarm communication device may receive registration information from multiple notification devices. For example, a first notification device may send a first registration information and a second notification device may send a second registration information.

The method 600 includes determining whether an alarm code has been received (act 606). Determining whether an alarm code has been received may include listening for an alarm code from a primary alarm system, such as the primary alarm system described in connection with FIG. 1. For example, the primary alarm system may detect an alert with an alert detector and send an alert code to an auxiliary alarm system, such as the auxiliary alert system and an alert detector 22 described in connection with FIG. 1. The alert code may be received by the auxiliary alarm communication device, such as auxiliary alarm communication device 70 described in connection with FIG. 1.

Sending the auxiliary alarm code may include sending multiple auxiliary alarm codes (e.g., to multiple notification devices). For example, a first auxiliary alarm code may be sent to a first notification device and a second auxiliary alarm code may be sent to a second notification device. In some embodiments where registration information is received from multiple notification devices, multiple auxiliary alarm codes may be sent. For example, the first auxiliary alarm code may include received first registration information and the second auxiliary alarm code may include received second registration information.

In other embodiments where registration information is received from multiple notification devices, a single auxiliary alarm code may be sent. For example, sending the auxiliary alarm code may include simply sending the auxiliary alarm code. For example, sending the auxiliary alarm code may include the process described in connection with FIG. 1 where the Radio Data System (RDS) may be used to broadcast the auxiliary alarm code. In some embodiments, where the auxiliary alarm code is simply sent, the auxiliary alarm code may be sent without receiving any registration information from the notification device. If the method 600 determines that an alarm code has been received, an auxiliary alarm code is sent to a notification device (act 608).

Sending the auxiliary alarm code may include using at least a portion of received registration information with the auxiliary alarm code. For example, if the received registration information included a device identifier, then the auxiliary alarm code could include at least a portion of the device identifier. In another example, the auxiliary alarm code could include at least a portion of a sent random number string that was received as registration information. In a further example, other more complex registration information may be included with the auxiliary alarm code.

In some embodiments, sending an availability announcement (act 602) and/or determining whether registration information has been received (act 604) may be omitted. For example, in embodiments where both sending an availability announcement (act 602) and determining whether registration information has been received (act 604) are omitted, after determining that an alarm code has been received (act 606), the auxiliary alarm may simply be sent.

In some embodiments, an auxiliary alarm communication device may provide additional information to a notification device. For example, referring back to FIG. 1, an auxiliary alarm communication device 70-3 in room 11-3 upon receiving an alert code from the primary alarm system may provide threat avoidance instructions to the user 90-3. In this example, the threat avoidance instructions may include instructions to exit the building 10 through the window 13-3 in room 11-3 and proceed down the fire escape 15. The exit instructions may be provided based on the location of the user 90-3, which may be determined based on the location beacon 60-3. The additional information may be communicated through a sensory pathway through which a user may be capable of appreciating the instructions.

FIG. 9 is an embodiment of an auxiliary alarm communication device 700. The auxiliary alarm communication device 700 includes an alert code receiving module 702. The alert code receiving module 702 may receive an alert code from a primary alarm system (e.g., the primary alarm system described in connection with FIG. 1). For example, the alert code receiving module 702 may receive an alert code over a network through a network communication module 720. The network communication module 720 may be the similar to the network communication device 520 described in connection with FIG. 9. For example, the network communication module 720 may include a wireless transceiver capable of communicating wirelessly with an auxiliary alarm communication device over at least one protocol.

The auxiliary alarm communication device 700 includes an auxiliary alarm communication module 704. The auxiliary alarm communication module 704 may send an auxiliary alarm code to a notification device as described in connection with act 608 in FIG. 8. The auxiliary alarm code may be sent using the network communication module 720.

The alert code receiving module 702 and/or the auxiliary alarm communication module 704 may determine whether an alarm code has been received (e.g., act 606 described in connection with FIG. 8).

The auxiliary alarm communication device 700 may include a registration module 706. The registration module 706 may determine whether registration information has been received (e.g., act 604 described in connection with FIG. 8). For example, the registration module 706 may be in electronic communication with the network communication module 720. The network communication module 720 may receive registration information from a notification device.

The registration module 706 may include registration data 710. The registration data 710 may be used to store registration information received from at least one notification device. A notification device may send a generated notification device token 712, which may be stored as registration data 710 using the registration module 706. The auxiliary alarm communication module 704 may use the registration data 710 (which may include a notification device token 712) when sending an auxiliary alarm code to a notification device (e.g., act 608 described in connection with FIG. 8).

Multiple notification devices may send corresponding registration information, which may be saved in the registration data 710 of the registration module 706. For example, multiple notification devices may send corresponding notification device tokens 712 (e.g., 712-1, 712-2, . . . 712-n) to the auxiliary alarm communication device 700. A first notification device may send a first notification device token 712-1 and a second notification device may send a second notification device token 712-2. The first notification device token 712-1 and the second notification device token 712-2 may be stored in the registration data 710.

Registration data 710, which may include the notification device tokens 712, may be used by the auxiliary alarm communication module 704 to send an alarm code to a notification device, which may provide the notification device the ability to verify the auxiliary alarm code is valid. For instance, referring to the example above, the first notification device may receive a first auxiliary alarm code that includes the first notification device token 712-1 and the second notification device may receive a second auxiliary alarm code that includes the second notification device token 712-2, which notification device tokens 712 may be used by their respective notification devices to determine whether the auxiliary alarm code is valid.

The auxiliary alarm communication device 700 may include a configuration module 714. The configuration module 714 may include modules for communicating configuration information to the auxiliary alarm communication device 700. Configuration information may include settings, modules, data, other information, or combinations thereof. For example, the configuration module 714 may include a USB port through which a firmware update may be communicated.

The preceding discussion refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Where doing so would not conflict with a description of a Figure herein, any act, component, information, or other element described herein may replace or be combined with other act, component, information, or other element described in conjunction with a description of any other Figure described herein. Thus, the descriptions any Figures herein is hereby incorporated by reference into the description of any other Figure herein. Such that, for example, the act (302) of registering a notification device, described in FIG. 5, may be incorporated into the method 200. In another example, the user input module 518 of FIG. 7 may be incorporated into the auxiliary alarm communication device 700 of FIG. 9. In a further example, customizing settings for a notification device (act 401) of FIG. 6 may be incorporated into the method 600 for communicating an auxiliary alarm of FIG. 8. Such that, unless expressly indicated otherwise, any act, component, information, or other element described herein may be claimed in conjunction with any other act, component, information, or other element described herein and such potential combination is hereby explicitly supported by this incorporation.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A notification device for providing an auxiliary alarm, the notification device comprising:
an auxiliary alarm device configured to provide sensory feedback;
a registration module configured to listen for an available auxiliary alarm system and configured to register the notification device with the auxiliary alarm system without providing personally identifying information to the auxiliary alarm system;
an auxiliary alarm receiving module configured to receive an auxiliary alarm code from the auxiliary alarm system; and
an auxiliary alarm activation module coupled to the auxiliary alarm device and configured to activate the auxiliary alarm device to provide an auxiliary alarm.

2. The notification device of claim 1, wherein the registration module registers the notification device by being in electronic communication with the auxiliary alarm system.

3. The notification device of claim 2, wherein the registration module registers the notification device with the auxiliary alarm system automatically without user interaction.

4. The notification device of claim 1, wherein the registration module is configured to listen for an availability announcement from the auxiliary alarm system.

5. The notification device of claim 4, further comprising a display configured to display the availability of the auxiliary alarm system.

6. The notification device of claim 1, wherein the auxiliary alarm receiving module is configured to determine whether the auxiliary alarm is valid.

7. The notification device of claim 1, wherein the registration module is configured to send a notification device token to the auxiliary alarm system.

8. The notification device of claim 7, wherein the auxiliary alarm receiving module determines whether the auxiliary alarm is valid by comparing the auxiliary alarm with the notification device token sent to the auxiliary alarm system.

9. The notification device of claim 1, wherein the auxiliary alarm activation module activates the auxiliary alarm device based on predetermined alarm criteria.

10. The notification device of claim 9, wherein the auxiliary alarm activation module is configured to store alert types.

11. The notification device of claim 10, wherein the auxiliary alarm activation module activates the auxiliary alarm device based on the stored alert types.

12. The notification device of claim 11, wherein whether the auxiliary alarm device is activated is user selectable based on the stored alert types.

13. The notification device of claim 11, wherein the stored alert types include stored threat types that include one or more of fire, smoke, tsunami, biological, chemical, flood, human, hurricane, tornado, radiation, nuclear, volcano, wildfire, thunderstorm, other threats, or a threat drill.

14. The notification device of claim 13, wherein additional information is provided to a user based on the stored alert type.

15. The notification device of claim 14, wherein the additional information includes threat avoidance instructions.

16. The notification device of claim 14, wherein the additional information is communicated to a user by one or more of haptics, auditory signals, and visual signals.

17. An auxiliary alarm communication device for communicating an auxiliary alarm, the auxiliary alarm communication device comprising:
a registration module configured to receive registration information from a notification device;
an alert receiving module configured to receive an alarm code from a primary alarm system; and
an auxiliary alarm communication module configured to send an auxiliary alarm code to the notification device.

18. The auxiliary alarm communication device of claim 17, wherein the registration module is configured to listen for an availability announcement from the notification device.

19. The auxiliary alarm communication device of claim 17, wherein the auxiliary alarm communication module is configured to combine the auxiliary alarm code with registration information received from the notification device.

20. A notification device for providing an auxiliary alarm, the notification device comprising:
a wearable haptic feedback device;
a registration module configured to listen for an available auxiliary alarm system and configured to send anonymous registration information to the auxiliary alarm system;
an auxiliary alarm receiving module configured to receive an auxiliary alarm code from the auxiliary alarm system and to determine whether the auxiliary alarm code is valid by comparing the auxiliary alarm code with the anonymous registration data sent to the auxiliary alarm system; and
an auxiliary alarm activation module coupled to the haptic feedback device and configured to activate the haptic feedback device to provide an auxiliary alarm based on user selectable predetermined criteria.
